(19) United States
(12) Patent Application Publication
(10) Pub. No.: US 2011/0274163 A1
(43) Pub. Date: Nov. 10, 2011

(54) VIDEO CODING APPARATUS AND VIDEO CODING METHOD

(76) Inventors: Kiyofumi ABE, Osaka (JP); Youji Shibahara, Osaka (JP); Koji Arimura, Osaka (JP); Hideyuki Ohgose, Osaka (JP); Yuki Maruyama, Osaka (JP)

(21) Appl. No.: 13/093,880

(22) Filed: Apr. 26, 2011

(30) Foreign Application Priority Data
Apr. 27, 2010 (JP) 2010-102765

(51) Int. Cl. H04N 7/26

(52) U.S. Cl. 375/240.03; 375/E07.14

(57) ABSTRACT

A video coding apparatus includes: a change amount detection unit that detects, based on pixel data included in a target block to be coded, an amount of change indicating a displacement between a top field and a bottom field caused by a difference in image capture time between the top field and the bottom field which are consecutive; a quantization width determination unit that determines, as a quantization width used for the target block, a first quantization width when the amount of change is a first value, and a second quantization width when the amount of change is a second value that is larger than the first value, the second quantization width being smaller than the first quantization width; and a quantization unit that quantizes the target block using the quantization width determined by the quantization width determination unit.

### BACKGROUND OF THE INVENTION

(1) Field of the Invention

The present invention relates to a video coding apparatus and a video coding method, and in particular relates to a video coding apparatus that codes a video signal of an interlaced structure.

(2) Description of the Related Art

With development of multimedia applications in recent years, it has become common to handle information of all media such as video, audio, and text in an integrated manner. Digitized video has an enormous amount of data, and so an information compression technology for video is essential for storage and transmission. It is also important to standardize the compression technology, in order to achieve interoperability of compressed video data. Examples of video compression technology standards include H.261, H.263, and H.264 of ITU-T (International Telecommunication Union-Telecommunication Standardization Sector), MPEG-1, MPEG-3, MPEG-4, and MPEG-4 AVC of ISO (International Organization for Standardization), and so on.

In such video coding, information is compressed by reducing redundancy in a temporal direction and a spatial direction. A picture that is intra-picture prediction coded without referencing a reference picture in order to reduce spatial redundancy is called an I picture. A picture that is inter-picture prediction coded by referencing only one picture in order to reduce temporal redundancy is called a P picture. A picture that is inter-picture prediction coded by simultaneously referencing two pictures is called a B picture. A picture mentioned here represents one target image that is to be coded, and is either a picture (one frame) coded as a frame structure or a picture (one field) coded as a field structure.

Each picture to be coded is divided into coding unit blocks called macroblocks. In a coding process, a video coding apparatus conducts intra-picture prediction or inter-picture prediction for each block. In detail, the video coding apparatus calculates a difference between an input image to be coded and a prediction image generated by prediction for each macroblock, performs orthogonal transformation such as discrete cosine transform on the calculated differential image, and quantizes each transform coefficient value resulting from the transformation. Information is compressed in this way.

Typically, coding as a frame structure (hereafter, frame structure coding) is used for progressive video in which one frame is composed of only an image captured at the same time. On the other hand, coding as a field structure (hereafter, field structure coding) is used for interlaced video in which one frame is composed of images of two fields captured at different times. In H.264 and the like, however, when coding interlaced video, one frame can be processed either as one frame or as two fields. Moreover, in H.264 and the like, the frame structure coding or the field structure coding can be selected for each macroblock in the frame. Thus, H.264 and the like incorporate a mechanism for enhancing coding efficiency by selecting an optimum processing method according to image characteristics.

In such a method of selectively applying the frame structure coding or the field structure coding to each macroblock in the frame, it is necessary to determine, for each macroblock, whether the frame structure coding or the field structure coding is suitable for the macroblock. For example, Japanese Patent No. 2991833 (hereafter, Patent Reference 1) proposes a technique of comparing a difference in pixel value between adjacent lines belonging to the same field and a difference in pixel value between adjacent lines belonging to different fields, and processing as the field structure when the former difference is smaller than the latter difference. Accordingly, when there is an area that differs in image between two fields due to local motion or shape change, the field structure coding is performed on such an area. The technique described in Patent Reference 1 can thus prevent image quality degradation.

### SUMMARY OF THE INVENTION

However, particularly in H.264, since coding is performed while frequently obtaining coding information of an adjacent area and a reference image, there is a problem that complex processing is required when a macroblock that is subject to the frame structure coding and a macroblock that is subject to the field structure coding are mixed in the same frame. This causes significant increases in the number of processing cycles and the number of memory accesses.

In view of this, there is an alternative method of selecting the frame structure coding or the field structure coding for each frame, as shown in FIG. 4. In FIG. 4, for interlaced input video that differs in image capture time between a top field and a bottom field, the frame structure coding is performed on Frm0 and Frm4, whereas the field structure coding is performed on the other frames. This enables, for example, such processing whereby the field structure coding is performed when the target image has large motion or shape change and so there is an image difference between the top field and the bottom field, and the frame structure coding is performed when the target image has little motion or shape change and so there is substantially no image difference between the top field and the bottom field.

In the method of selecting the frame structure coding or the field structure coding for each frame, however, there is a tendency that, when most parts of the frame have little change and only one local part of the frame has a large change, the frame structure coding contributes to high coding efficiency for the frame as a whole but, with regard only to the local area having the large change, rather causes poor coding efficiency.

FIG. 5 is a diagram showing an example where the frame structure coding is performed on an interlaced image locally having a moving circular object. In this case, two images of the moving circular object that are displaced from each other by one pixel line are coded as a frame. Such an area contains an image having a low spatial correlation, leading to poor coding efficiency. When the frame structure coding is performed on this image, image quality degradation of blurriness caused by mixture of the images of the two fields in the area having motion tends to occur.

FIG. 6 is a diagram showing an example of an image obtained by decoding the coded image shown in FIG. 5. As shown in FIG. 6, the moving circular object is blurred in the decoded image.

Thus, the conventional technique has a problem of causing image quality degradation in a local area having a change.

The present invention has been made to solve the conventional problem stated above, and has an object of providing a video coding apparatus and a video coding method that can prevent image quality degradation in a local area having a change, when performing the frame structure coding on interlaced video.

To solve the conventional problem, a video coding apparatus according to one aspect of the present invention is a video coding apparatus that codes, on a block-by-block basis, each frame included in a video signal of an interlaced structure, the frame being composed of a top field and a bottom field which are consecutive, the video coding apparatus including: a change amount detection unit that detects, based on pixel data included in a target block to be coded, an amount of change indicating a displacement between the top field and the bottom field caused by a difference in image capture time between the top field and the bottom field which are consecutive; a quantization width determination unit that determines, as a quantization width used for the target block, a first quantization width when the amount of change is a first value, and a second quantization width when the amount of change is a second value that is larger than the first value, the second quantization width being smaller than the first quantization width; and a quantization unit that quantizes the target block using the quantization width determined by the quantization width determination unit.

According to this structure, when performing the frame structure coding, the video coding apparatus according to one aspect of the present invention determines the amount of change between the top field and the bottom field for each block, and uses a smaller quantization width when the amount of change is large. In this way, the video coding apparatus according to one aspect of the present invention can reduce a phenomenon in which the image of the top field and the image of the bottom field are mixed in an area having a large amount of change. Hence, the video coding apparatus according to one aspect of the present invention can prevent image quality degradation in a local area having a change, when performing the frame structure coding on interlaced video.

Moreover, the quantization width determination unit may include: a quantization width calculation unit that calculates a base quantization width for the target block; a modification unit that generates a modified quantization width, by modifying the base quantization width to a smaller quantization width; and a selection unit that determines, as the quantization width used for the target block, the base quantization width when the amount of change is the first value, and the modified quantization width when the amount of change is the second value that is larger than the first value.

According to this structure, the video coding apparatus according to one aspect of the present invention can use a smaller quantization width than a normal quantization width, when there is a large amount of change between the top field and the bottom field.

Moreover, the change amount detection unit may detect a difference in pixel value between the top field and the bottom field in the target block, as the amount of change.

According to this structure, the video coding apparatus according to one aspect of the present invention can prevent image quality degradation caused by mixture of the top field and the bottom field in an area having motion or shape change. In addition, since the video coding apparatus according to one aspect of the present invention sets a smaller quantization width for an area that has no motion but has shape change, image quality degradation can be prevented in a wider range.

Moreover, the change amount detection unit may detect motion of the target block, as the amount of change.

According to this structure, the video coding apparatus according to one aspect of the present invention can prevent image quality degradation caused by mixture of the top field and the bottom field in an area having motion. Besides, the same motion information can be used in the determination and in another step of the coding process. Therefore, the video coding apparatus according to one aspect of the present invention can achieve the intended advantageous effect without an increase in processing amount.

Moreover, the video coding apparatus may further include a coding structure selection unit that selects, for each frame included in the video signal, one of field structure coding and frame structure coding, the field structure coding being a method of separately coding the top field and the bottom field of the frame, and the frame structure coding being a method of coding the top field and the bottom field of the frame as one frame, wherein the quantization width determination unit: determines, as the quantization width used for the target block, the base quantization width when the amount of change is the first value, and the modified quantization width when the amount of change is the second value, in the case where the coding structure selection unit selects the frame structure coding for a target frame to be coded; and determines the base quantization width as the quantization width used for the target block, in the case where the coding structure selection unit selects the field structure coding for the target frame.

According to this structure, the video coding apparatus according to one aspect of the present invention selects the frame structure coding or the field structure coding, for each frame. In so doing, the video coding apparatus according to one aspect of the present invention can reduce processing complexity.

Moreover, the video coding apparatus may further code, on the block-by-block basis, each frame included in a video signal of a progressive structure, wherein the quantization width determination unit: determines, as the quantization width used for the target block, the base quantization width when the amount of change is the first value, and the modified quantization width when the amount of change is the second value, in the case where the video coding apparatus codes the frame included in the video signal of the interlaced structure; and determines the base quantization width as the quantization width used for the target block, in the case where the video coding apparatus codes the frame included in the video signal of the progressive structure.

Note that the present invention can be realized not only as the video coding apparatus described above, but also as a video coding method including steps corresponding to the characteristic units included in the video coding apparatus, or a program causing a computer to execute such characteristic steps. The program may be distributed via a recording medium such as a CD-ROM or a transmission medium such as the Internet.

Furthermore, the present invention can also be realized as a semiconductor integrated circuit (LSI) that implements a part or all of the functions of the video coding apparatus.

### ADVANTAGEOUS EFFECTS OF INVENTION

As described above, the present invention can provide a video coding apparatus and a video coding method that can prevent image quality degradation in a local area having a change, when coding interlaced video.

### FURTHER INFORMATION ABOUT TECHNICAL BACKGROUND TO THIS APPLICATION

The disclosure of Japanese Patent Application No. 2010-102765 filed on Apr. 27, 2010 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a structure of a video coding apparatus according to an embodiment of the present invention;

FIG. 2A is a diagram showing an example of a coefficient after quantizing an orthogonal transform coefficient using a large quantization width;

FIG. 2B is a diagram showing an example of a coefficient after quantizing the orthogonal transform coefficient using a small quantization width;

FIG. 3 is a flowchart of a quantization width determination process by the video coding apparatus according to the embodiment;

FIG. 4 is a diagram showing a situation where interlaced video is coded by frame structure coding and field structure coding;

FIG. 5 is a diagram explaining a problem when the frame structure coding is performed on an interlaced image that includes a local area having motion; and

FIG. 6 is a diagram explaining the problem when the frame structure coding is performed on the interlaced image that includes the local area having motion.

### DESCRIPTION OF THE PREFERRED EMBODIMENT(S)

The following describes video coding according to an embodiment of the present invention in detail, with reference to drawings.

A video coding apparatus according to this embodiment selects frame structure coding or field structure coding, for each frame. In so doing, the video coding apparatus according to this embodiment can reduce processing complexity.

Moreover, when performing the frame structure coding, the video coding apparatus according to this embodiment determines, for each macroblock, a correlation between a top field and a bottom field, and sets a smaller quantization width than a normal quantization width when the correlation is low. By using a smaller quantization width for an area having a low correlation in such a way, the video coding apparatus according to this embodiment can prevent image quality degradation in the area. Thus, the video coding apparatus according to this embodiment achieves both reduced processing complexity and enhanced image quality.

A structure of the video coding apparatus according to this embodiment is described first.

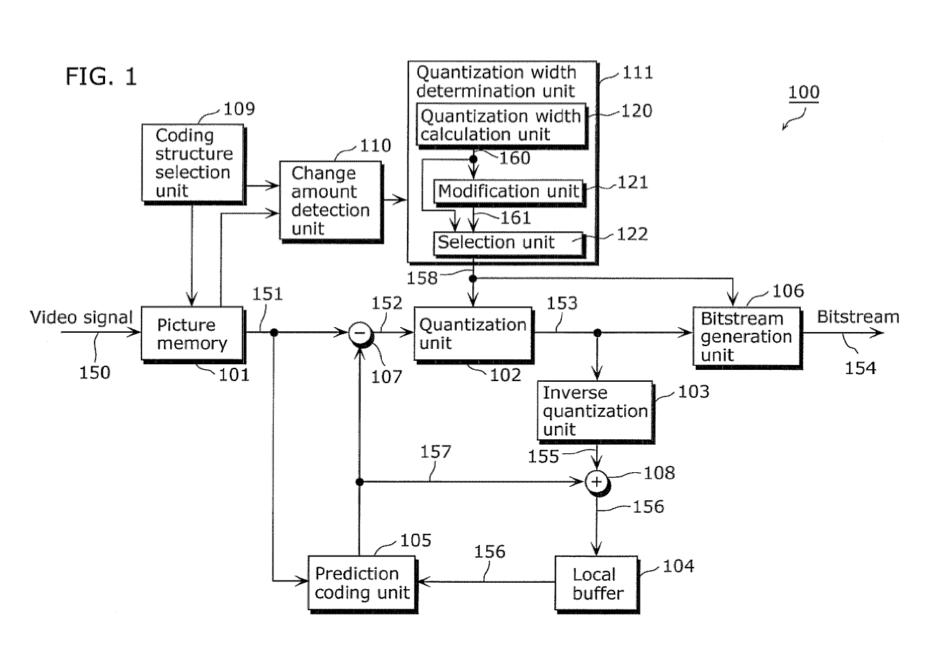

FIG. 1 is a block diagram of a video coding apparatus 100 according to this embodiment.

The video coding apparatus 100 shown in FIG. 1 codes a video signal 150 of an interlaced structure, to generate a bitstream 154. The video coding apparatus 100 includes a picture memory 101, a quantization unit 102, an inverse quantization unit 103, a local buffer 104, a prediction coding unit 105, a bitstream generation unit 106, a coding structure selection unit 109, a change amount detection unit 110, and a quantization width determination unit 111.

The picture memory 101 stores the video signal 150 that is inputted on a picture-by-picture basis in display order, after sorting pictures in coding order. Upon receiving a read instruction from a subtraction unit 107 and the prediction coding unit 105, the picture memory 101 outputs the video signal 150 related to the read instruction, as an input image signal 151.

Note that each picture is divided into blocks of, for example, horizontal 16 pixels×vertical 16 pixels, which are called macroblocks (MBs). The video coding apparatus 100 performs subsequent processing on a MB-by-MB basis. The video signal 150 inputted here is assumed to be interlaced video in which one frame is composed of images of two fields (the top field and the bottom field) captured at different times.

Note that the unit of processing is not limited to a MB, and may be a block of a predetermined size.

The quantization unit 102 performs orthogonal transformation on a differential image signal 152 outputted from the subtraction unit 107. The quantization unit 102 also quantizes the orthogonally transformed differential image signal using a quantization value (QP (Quantization Parameter) value) 158 determined by the quantization width determination unit 111, to generate a residual coded signal 153. The quantization unit 102 outputs the generated residual coded signal 153 to the inverse quantization unit 103 and the bitstream generation unit 106. Here, the quantization unit 102 performs quantization on an orthogonal transform coefficient of each frequency component obtained as a result of the orthogonal transformation, using the QP value 158 determined on a MB-by-MB basis and a coefficient value in a separately designated quantization matrix at a position corresponding to the frequency component.

The inverse quantization unit 103 performs inverse quantization and inverse orthogonal transformation on the residual coded signal 153 outputted from the quantization unit 102, to generate a residual decoded signal 155. The inverse quantization unit 103 outputs the generated residual decoded signal 155 to an addition unit 108.

The local buffer 104 stores, from among a signal outputted from the addition unit 108, a reconstructed image signal 156 having a possibility of being referenced when inter-picture prediction coding any MB which follows a current target MB to be coded.

The prediction coding unit 105 generates a prediction image signal 157 based on the input image signal 151 outputted from the picture memory 101, through intra-picture prediction or inter-picture prediction. The prediction coding unit 105 outputs the generated prediction image signal 157 to the subtraction unit 107 and the addition unit 108. Note that the prediction coding unit 105 performs inter-picture prediction using the reconstructed image signal 156 of an already coded picture in the local buffer 104, and intra-picture prediction using the reconstructed image signal 156 of an already coded MB adjacent to the target MB.

The bitstream generation unit 106 performs variable length coding on the residual coded signal 153 outputted from the quantization unit 102, the QP value 158 outputted from the quantization width determination unit 111, and the like, to generate the bitstream 154.

The subtraction unit 107 generates the differential image signal 152 which is a difference between the input image signal 151 read from the picture memory 101 and the prediction image signal 157 outputted from the prediction coding unit 105. The subtraction unit 107 outputs the generated differential image signal 152 to the quantization unit 102.

The addition unit 108 generates the reconstructed image signal 156, by adding the residual decoded signal 155 outputted from the inverse quantization unit 103 and the prediction image signal 157 outputted from the prediction coding unit 105. The addition unit 108 outputs the generated reconstructed image signal 156 to the local buffer 104.

The coding structure selection unit 109 selects, for each frame, whether the input target frame is to be coded as a frame structure (frame structure coding) or coded as a field structure (field structure coding). The field structure coding is a method of separately coding the top field and the bottom field of the frame, whereas the frame structure coding is a method of coding the top field and the bottom field of the frame as one frame.

An arbitrary method may be used to determine whether the target frame is to be processed as the frame structure or the field structure. For example, the coding structure selection unit 109 selects the field structure coding for the target frame when a correlation between the top field and the bottom field in the target frame is lower than a predetermined second threshold, and selects the frame structure coding for the target frame when the correlation between the top field and the bottom field in the target frame is higher than the second threshold.

In detail, the coding structure selection unit 109 checks motion of the entire frame. When the motion is fast, the coding structure selection unit 109 selects the field structure coding. When the motion is slow, the coding structure selection unit 109 selects the frame structure coding. Alternatively, the coding structure selection unit 109 may select the field structure coding for the target frame when there is a large difference in pixel value between the top field and the bottom field in the target frame, and select the frame structure coding for the target frame when there is a small difference in pixel value between the top field and the bottom field in the target frame.

As another alternative, the coding structure selection unit 109 may select the frame structure coding when coding the target frame as an I picture, and select the field structure coding when coding the target frame as a P picture or a B picture.

Moreover, the coding structure selection unit 109 may perform the selection according to an instruction from outside the video coding apparatus 100. Furthermore, the coding structure selection unit 109 may combine the above selection methods.

The change amount detection unit 110 determines whether or not the current target MB includes an image having a change with time, using the input image signal stored in the picture memory 101 and a signal indicating the coding structure selected by the coding structure selection unit 109. In detail, the change amount detection unit 110 detects an amount of change between the top field and the bottom field, based on pixel data included in the target MB. The amount of change mentioned here indicates a displacement between the top field and the bottom field caused by a difference in image capture time between the top field and the bottom field which are consecutive. In other words, the amount of change indicates the correlation between the top field and the bottom field.

In more detail, when the coding structure selection unit 109 selects the frame structure coding for the target frame, the change amount detection unit 110 determines, for each MB included in the target frame, whether or not the amount of change between the top field and the bottom field in the MB is smaller than a predetermined first threshold. That is, the change amount detection unit 110 determines, for each MB included in the target frame, whether or not the correlation between the top field and the bottom field in the MB is higher than a predetermined threshold.

For example, the change amount detection unit 110 determines that the amount of change between the top field and the bottom field in the target MB is smaller than the first threshold, when motion of the target MB is smaller than a predetermined third threshold. On the other hand, the change amount detection unit 110 determines that the amount of change between the top field and the bottom field in the target MB is larger than the first threshold, when the motion of the target MB is larger than the third threshold.

Alternatively, the change amount detection unit 110 may determine that the amount of change between the top field and the bottom field in the target MB is smaller than the first threshold when the difference in pixel value between the top field and the bottom field in the target MB is smaller than a predetermined fourth threshold, and determine that the amount of change between the top field and the bottom field in the target MB is larger than the first threshold when the difference in pixel value between the top field and the bottom field in the target MB is larger than the fourth threshold.

The change amount detection unit 110 outputs a result of the determination to the quantization width determination unit 111.

The quantization width determination unit 111 determines the QP value 158 (quantization width) used for quantizing the target MB, based on the determination result of the change amount detection unit 110. The quantization width determination unit 111 outputs the determined QP value 158 to the quantization unit 102 and the bitstream generation unit 106. The QP value 158 is used by the quantization unit 102 to perform quantization. The QP value 158 is also variable length coded by the bitstream generation unit 106. As a result, information of the QP value 158 is included in the bitstream 154.

The quantization width determination unit 111 includes a quantization width calculation unit 120, a modification unit 121, and a selection unit 122.

The quantization width calculation unit 120 calculates a normal QP value 160 (base quantization width) for the target MB, according to a normal method.

The modification unit 121 generates a modified QP value 161 (modified quantization width), by modifying the normal QP value 160 calculated by the quantization width calculation unit 120 to a smaller quantization width. In detail, the modification unit 121 calculates the modified QP value 161, by multiplying the normal QP value 160 by a predetermined coefficient or subtracting the predetermined coefficient from the normal QP value 160. Here, the modification unit 121 may generate a smaller modified QP value 161 when the amount of change between the top field and the bottom field is larger.

The selection unit 122 selects the normal QP value 160 as the QP value 158, when the coding structure selection unit 109 selects the field structure coding and when the change amount detection unit 110 determines that the amount of change between the top field and the bottom field in the target MB is small. The selection unit 122 selects the modified QP value 161 as the QP value 158, when the change amount detection unit 110 determines that the amount of change between the top field and the bottom field in the target MB is large.

The following describes a detailed method of determining the QP value 158 for the target MB in the change amount detection unit 110 and the quantization width determination unit 111, with reference to drawings.

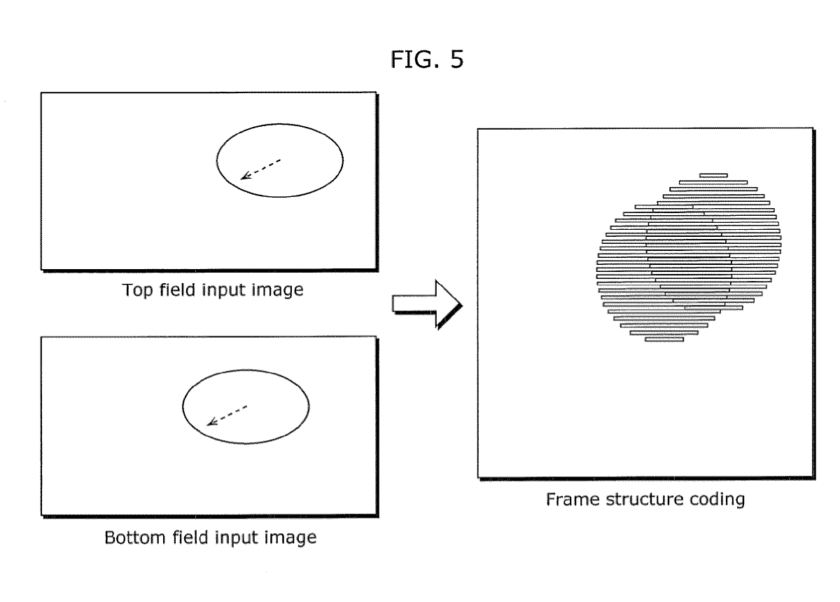

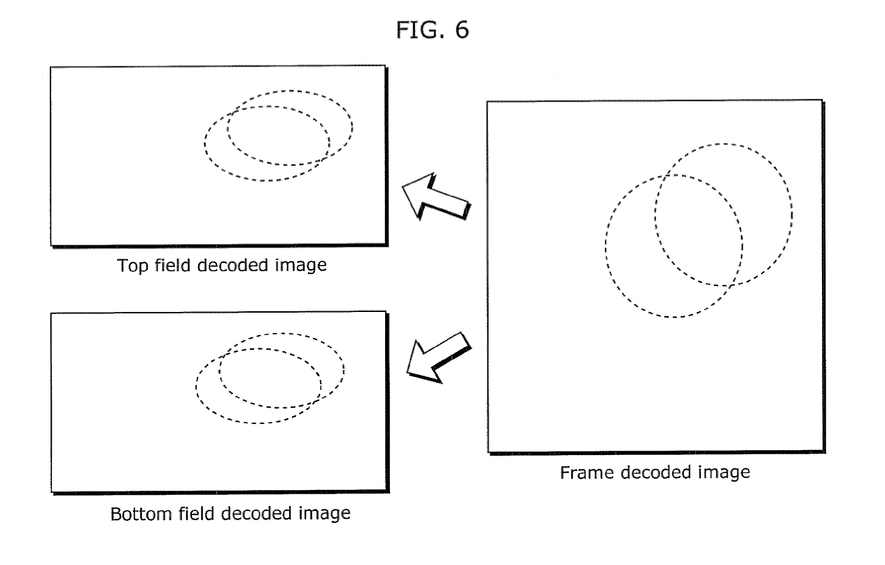

Suppose there is an object that moves or changes in shape with time between the top field and the bottom field which compose the same frame, as shown in FIG. 5. When performing the frame structure coding on such an input image, an area having the object is processed as images that are displaced from each other by one pixel line. In particular, a MB corresponding to such an area includes an image having a significant variation in pixel value of each pixel position.

In most cases, the differential image signal 152 generated by taking the difference from the prediction image signal 157 for such a MB by the subtraction unit 107 exhibits the same characteristics, too. When this differential image signal 152 is orthogonally transformed to be divided into frequency components in the quantization unit 102, many components appear in a high frequency region.

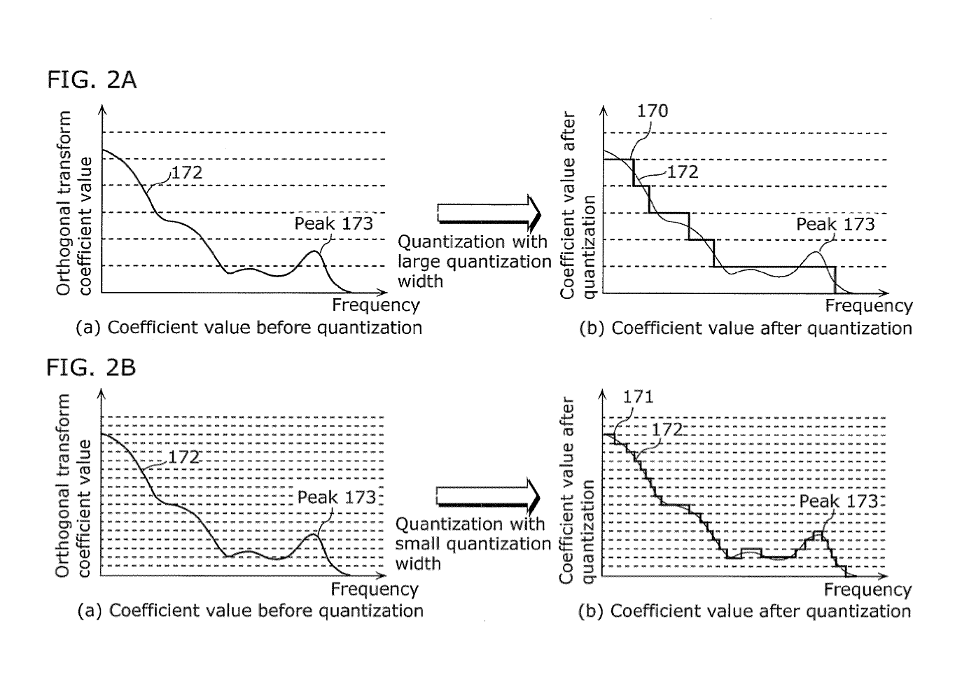

FIGS. 2A and 2B are each a diagram showing a phenomenon when quantization is performed on an orthogonal transform coefficient having such characteristics.

FIG. 2A (a) and FIG. 2B (a) each show an orthogonal transform coefficient value before quantization. In each of FIG. 2A (a) and FIG. 2B (a), a horizontal axis represents a frequency domain, and a vertical axis represents a coefficient value of each frequency component after orthogonal transformation. FIG. 2A (b) and FIG. 2B (b) each show a coefficient value after quantization. In each of FIG. 2A (b) and FIG. 2B (b), a horizontal axis represents a frequency domain, and a vertical axis represents a coefficient value of each frequency component after quantization. FIG. 2A shows a situation where quantization is performed using a large quantization width, while FIG. 2B shows a situation where quantization is performed using a small quantization width.

As shown in FIG. 2A (a), a component of a large coefficient value appears in a high frequency region as a peak 173, in a solid line 172. A coefficient value after quantizing this using a large QP value (large quantization width) is indicated by a solid line 170 in FIG. 2A (b). As shown in FIG. 2A (b), the peak 173 present before quantization is completely crushed as a result of quantization, so that the peak characteristics in the high frequency component region are lost. When inverse quantization and inverse orthogonal transformation are performed on such a coefficient to generate a reconstructed image, the characteristics of the images that are displaced from each other by one pixel line as in the input image cannot be accurately recreated, resulting in such an image where the images displaced from each other by one pixel line are mixed. Displaying the top field and the bottom field of this image in sequence as video yields a blurred image with degraded image quality.

On the other hand, a coefficient value after quantizing the same orthogonal transform coefficient as in FIG. 2A using a small QP value (small quantization width) is indicated by a solid line 171 in FIG. 2B (b). The peak 173 present before quantization remains in a substantially same form even after quantization. When inverse quantization and inverse orthogonal transformation are performed on such a coefficient to generate a reconstructed image, the characteristics of the images that are displaced from each other by one pixel line as in the input image can be recreated roughly accurately. Displaying the top field and the bottom field of this image in sequence as video yields a clear image with little image quality degradation. Thus, image quality degradation in a local area having a change can be prevented.

Though FIGS. 2A and 2B each show an example where quantization is performed with the same quantization width from low to high frequency regions for simplicity's sake, a different quantization width may be used for each frequency region through the use of a quantization matrix. In the case of using the quantization matrix, the quantization width is typically set to be larger in a high frequency region than in a low frequency region. Such quantization further increases the difference of degradation in high frequency component due to the QP value difference mentioned above, as a result of which the image quality of the reconstructed image is affected more significantly.

In view of this, the present invention specifies an area having a high possibility of encountering the above problem, and exercises control so that a MB of such an area is coded with a smaller QP value (smaller quantization width), thereby preventing image quality degradation.

The following describes an operation of the video coding apparatus 100.

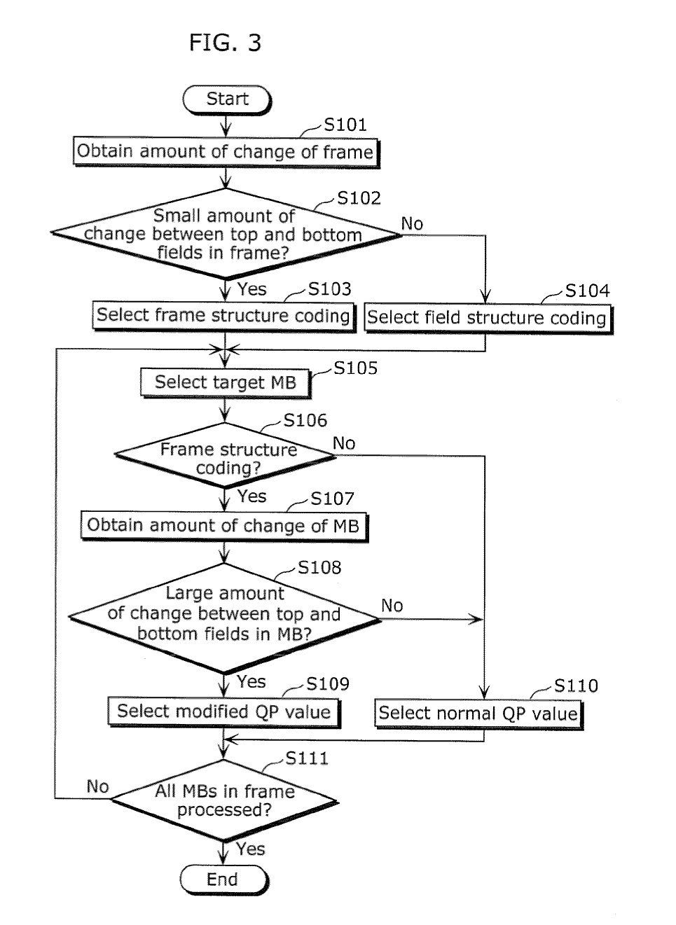

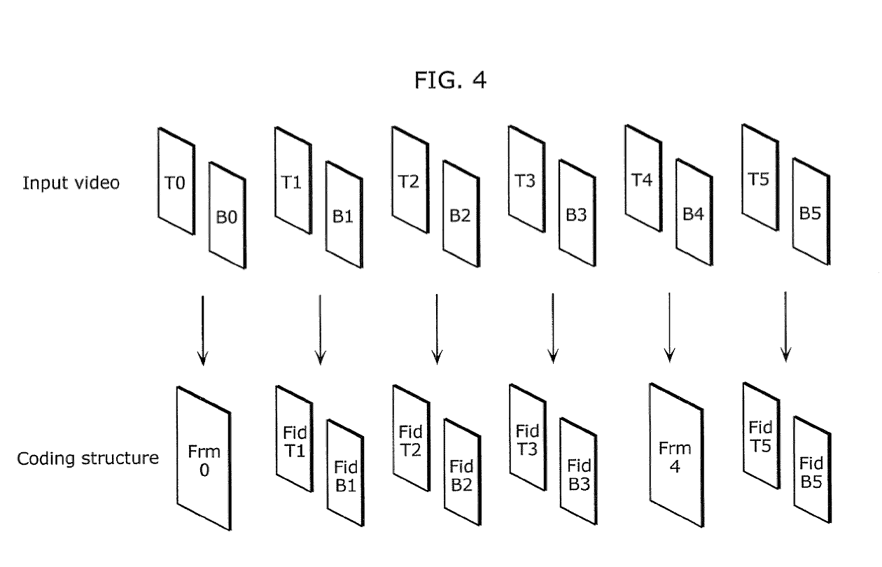

FIG. 3 is a flowchart of a process of determining the QP value 158 for the target MB by the video coding apparatus 100. A process performed on one target frame is shown in FIG. 3. It is assumed here that the video signal 150 is interlaced video.

First, the coding structure selection unit 109 determines whether the frame structure coding or the field structure coding is to be applied to the target frame.

In detail, the coding structure selection unit 109 obtains the amount of change of the target frame (Step S101). For instance, the amount of change is information indicating motion of the entire target frame.

Next, the coding structure selection unit 109 determines whether or not the amount of change between the top field and the bottom field of the target frame is smaller than a predetermined threshold, using the amount of change obtained in Step S101 (Step S102). For example, the coding structure selection unit 109 determines whether or not the motion of the entire target frame is smaller than a predetermined threshold.

When the amount of change between the top field and the bottom field of the target frame is smaller than the predetermined threshold (Step S102: Yes), the coding structure selection unit 109 selects the frame structure coding (Step S103).

When the amount of change between the top field and the bottom field of the target frame is equal to or larger than the predetermined threshold (Step S102: No), on the other hand, the coding structure selection unit 109 selects the field structure coding (Step S104).

Following this, the video coding apparatus 100 selects the target MB in the target frame (Step S105).

When the frame structure coding is selected for the target frame (Step S106: Yes), the change amount detection unit 110 obtains the amount of change of the target MB (Step S107), and determines whether or not the amount of change between the top field and the bottom field in the target MB is equal to or larger than a predetermined threshold, using the obtained amount of change (Step S108).

In detail, the change amount detection unit 110 determines, for example, whether or not the target MB belongs to an area having fast motion with respect to the frame. Fast motion indicates a large amount of change (low correlation), whereas slow motion indicates a small amount of change (high correlation). Note that an arbitrary determination method may be used to determine whether or not the target MB belongs to an area having fast motion with respect to the frame. One example of such a method is to conduct motion prediction on the target MB by referencing an already coded picture, and make the determination depending on whether or not detected motion information is larger than a threshold defined beforehand. Another method is to make the determination depending on whether or not motion information detected when coding a MB in an already coded picture at the same position as the target MB is larger than a threshold defined beforehand. Yet another method is to conduct motion prediction for each of a plurality of areas obtained by dividing the target picture, classify each area as a motion area or a still area according to whether or not detected motion information is larger than a threshold defined beforehand, and make the determination depending on whether or not the target MB belongs to the motion area.

This method enables highly accurate determination of whether or not the target MB belongs to an area having motion, with it being possible to prevent image quality degradation caused by mixture of the top field and the bottom field in an area having motion. Moreover, the same motion information can be used in the determination and in another step of the coding process, so that the intended advantageous effect can be achieved without an increase in processing amount.

The change amount detection unit 110 may also determine whether or not the target MB belongs to an area having a large difference in pixel value between the pair of fields at the same pixel position. A large difference indicates a large amount of change (low correlation), whereas a small difference indicates a small amount of change (high correlation). Note that an arbitrary determination method may be used to determine whether or not the target MB belongs to an area having a large difference in pixel value between the pair of fields at the same pixel position. One example of such a method is to compare a pixel value difference between adjacent pixel lines at the same pixel position with a pixel value difference between adjacent-but-one pixel lines at the same pixel position in the target MB, and make the determination depending on whether or not the former correlation is extremely larger than the latter correlation. Another method is to compare, for each of a plurality of areas obtained by dividing the target picture, a pixel value difference between adjacent pixel lines at the same pixel position with a pixel value difference between adjacent-but-one pixel lines at the same position in the area, classify each area as a change area or a non-change area according to whether or not the former correlation is extremely larger than the latter correlation, and make the determination depending on whether or not the target MB belongs to the change area. Belonging to the change area indicates a large amount of change (low correlation), whereas belonging to the non-change area indicates a small amount of change (high correlation).

This method enables highly accurate determination of whether or not the target MB belongs to an area having motion or shape change, with it being possible to prevent image quality degradation caused by mixture of the top field and the bottom field in an area having motion or shape change.

Comparison between the difference-based method and the motion-based method demonstrates the following. In the motion-based method, the normal QP value 160 is selected for an area having no motion, even though the area has shape change. In the difference-based method, on the other hand, a smaller QP value (the modified QP value 161) is selected for an area that has no motion but has shape change or luminance change, so that image quality degradation can be prevented in a wider range.

Note that the change amount detection unit 110 may use only one of the motion-based method and the difference-based method, or combine the two methods.

When the amount of change between the top field and the bottom field in the target MB is equal to or larger than the predetermined threshold (Step S108: Yes), the quantization width determination unit 111 sets the QP value 158 used for quantizing the target MB, to be smaller than that of a normal MB. In detail, the quantization width calculation unit 120 calculates the normal QP value 160 according to a predetermined condition. The modification unit 121 modifies the normal QP value 160, thereby calculating the modified QP value 161 smaller than the normal QP value 160. The quantization width determination unit 111 selects the calculated modified QP value 161 as the QP value 158 (Step S109).

On the other hand, when the amount of change between the top field and the bottom field in the target MB is smaller than the predetermined threshold (Step S108: No) or when the coding structure selection unit 109 selects the field structure coding for the target frame (Step S106: No), the quantization width determination unit 111 selects the normal QP value 160 as the QP value 158 used for quantizing the target MB (Step S110).

A method of calculating the normal QP value 160 by the quantization width calculation unit 120 is not particularly limited. For instance, the quantization width calculation unit 120 calculates the normal QP value 160 based on rate control and image characteristics. In detail, the quantization width calculation unit 120 changes the normal QP value 160 according to image motion, color, pattern, and the like. As an example, the quantization width calculation unit 120 may increase the normal QP value 160 when there is fast motion. Moreover, the quantization width calculation unit 120 may decrease the normal QP value 160 when the target MB includes a specific color (such as human skin color) easily perceived by humans.

After the QP value 158 of the target MB is selected in Step S109 or S110, the quantization unit 102 quantizes the target MB using the selected QP value 158.

When the QP value 158 has not been determined for all MBs included in the target frame (Step S111: No), the process from Step 105 is performed on the next target MB. When the QP value 158 has been determined for all MBs included in the target frame (Step S111: Yes), the process from Step S101 is performed on the next target frame.

Though the above describes the case where the quantization width determination unit 111 includes the quantization width calculation unit 120 and the modification unit 121, these processing units represent the functions of the quantization width determination unit 111, and the functions of the quantization width calculation unit 120 and the modification unit 121 may instead by realized by one processing unit. That is, the quantization width determination unit 111 may calculate the modified QP value 161, through the use of a single operation that produces the same result as the two operations, namely, the calculation of the normal QP value and the modification of the normal QP value.

Besides, the quantization width determination unit 111 may use a predetermined fixed value as the modified QP value 161, instead of calculating the modified QP value 161 by modifying the normal QP value 160.

The video coding apparatus 100 may also have a function of coding each frame included in a video signal of a progressive structure, on a block-by-block basis. When coding each frame included in the video signal of the progressive structure, the quantization width determination unit 111 determines the normal QP value 160 as the QP value 158 used for the target MB.

As described above, the video coding apparatus 100 according to this embodiment selects the frame structure coding or the field structure coding, for each frame. In so doing, the video coding apparatus according to this embodiment can reduce processing complexity.

Moreover, when performing the frame structure coding on interlaced video, the video coding apparatus 100 according to this embodiment detects a MB having a change between the top field and the bottom field, and sets a QP value of the MB to be smaller than a QP value of a normal MB. Hence, the video coding apparatus 100 can prevent image quality degradation caused by a phenomenon in which the top field and the bottom field are locally mixed, enabling generation of a coded image of enhanced image quality.

Thus, the video coding apparatus 100 according to this embodiment achieves both reduced processing complexity and enhanced image quality.

### OTHER EMBODIMENTS

A program including the same functions as the processing units included in the video coding apparatus described in the above embodiment may be recorded on a recording medium such as a flexible disk. This allows the processing described in the above embodiment to be easily implemented on an independent computer system. The recording medium is not limited to a flexible disk, as any recording medium on which a program can be recorded, such as an optical disc, an IC card, and a ROM cassette, is equally applicable.

The same functions as the processing units included in the video coding apparatus described in the above embodiment may be realized as an LSI which is an integrated circuit. These functions may be partly or wholly implemented on one chip. The LSI may be referred to as any of an IC, a system LSI, a super LSI, and an ultra LSI, depending on the degree of integration.

The integrated circuit method is not limited to an LSI, and may be realized by a dedicated circuit or a general-purpose processor. A FPGA (Field Programmable Gate Array) that can be programmed after LSI manufacturing or a reconfigurable processor capable of reconfiguring connections and settings of circuit cells in an LSI may also be used.

When an integrated circuit technique that replaces an LSI and the like emerges from advancement of semiconductor technologies or other derivative technologies, such a technique may be used for the functional block integration.

The present invention is also applicable to a broadcast wave recording apparatus, such as a DVD recorder or a BD recorder, that includes the video coding apparatus described above and compresses and records a broadcast wave broadcast from a broadcast station.

At least a part of the functions of the video coding apparatus according to the above embodiment and its variations may be combined.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to a video coding apparatus, and useful for a video camera, a video recorder, a DVD apparatus, a mobile phone, a personal computer, and the like.

What is claimed is:

1. A video coding apparatus that codes, on a block-by-block basis, each frame included in a video signal of an interlaced structure, the frame being composed of a top field and a bottom field which are consecutive, said video coding apparatus comprising:
a change amount detection unit configured to detect, based on pixel data included in a target block to be coded, an amount of change indicating a displacement between the top field and the bottom field caused by a difference in image capture time between the top field and the bottom field which are consecutive;
a quantization width determination unit configured to determine, as a quantization width used for the target block, a first quantization width when the amount of change is a first value, and a second quantization width when the amount of change is a second value that is larger than the first value, the second quantization width being smaller than the first quantization width; and
a quantization unit configured to quantize the target block using the quantization width determined by said quantization width determination unit.

2. The video coding apparatus according to claim 1,
wherein said quantization width determination unit includes:
a quantization width calculation unit configured to calculate a base quantization width for the target block;
a modification unit configured to generate a modified quantization width, by modifying the base quantization width to a smaller quantization width; and
a selection unit configured to determine, as the quantization width used for the target block, the base quantization width when the amount of change is the first value, and the modified quantization width when the amount of change is the second value that is larger than the first value.

3. The video coding apparatus according to claim 1,
wherein said change amount detection unit is configured to detect a difference in pixel value between the top field and the bottom field in the target block, as the amount of change.

4. The video coding apparatus according to claim 1,
wherein said change amount detection unit is configured to detect motion of the target block, as the amount of change.

5. The video coding apparatus according to claim 2, further comprising
a coding structure selection unit configured to select, for each frame included in the video signal, one of field structure coding and frame structure coding, the field structure coding being a method of separately coding the top field and the bottom field of the frame, and the frame structure coding being a method of coding the top field and the bottom field of the frame as one frame,
wherein said quantization width determination unit is configured to:
determine, as the quantization width used for the target block, the base quantization width when the amount of change is the first value, and the modified quantization width when the amount of change is the second value, in the case where said coding structure selection unit selects the frame structure coding for a target frame to be coded; and
determine the base quantization width as the quantization width used for the target block, in the case where said coding structure selection unit selects the field structure coding for the target frame.

6. The video coding apparatus according to claim 2 that further codes, on the block-by-block basis, each frame included in a video signal of a progressive structure,
wherein said quantization width determination unit is configured to:
determine, as the quantization width used for the target block, the base quantization width when the amount of change is the first value, and the modified quantization width when the amount of change is the second value, in the case where said video coding apparatus codes the frame included in the video signal of the interlaced structure; and
determine the base quantization width as the quantization width used for the target block, in the case where said video coding apparatus codes the frame included in the video signal of the progressive structure.

7. A video coding method of coding, on a block-by-block basis, each frame included in a video signal of an interlaced structure, the frame being composed of a top field and a bottom field which are consecutive, said video coding method comprising:
detecting, based on pixel data included in a target block to be coded, an amount of change indicating a displacement between the top field and the bottom field caused by a difference in image capture time between the top field and the bottom field which are consecutive;
determining, as a quantization width used for the target block, a first quantization width when the amount of change is a first value, and a second quantization width when the amount of change is a second value that is larger than the first value, the second quantization width being smaller than the first quantization width; and
quantizing the target block using the quantization width determined in said determining.
